(19) United States
(12) Patent Application Publication
(10) Pub. No.: US 2007/0088731 A1
(43) Pub. Date: Apr. 19, 2007

(54) Method and apparatus for improved processing and analysis of complex hierarchic data

(76) Inventors: Dale Morris Chant, Ferntree Gully (AU); Roland Geoffrey Seidel, Selby (AU)

Correspondence Address: FISH & RICHARDSON P.C., P.O. BOX 1022, MINNEAPOLIS, MN, 55440-1022, US

(21) Appl. No.: 11/255,554

(22) Filed: Oct. 21, 2005

(30) Foreign Application Priority Data
Oct. 17, 2005 (AU) 2005905708

(51) Int. Cl. G06F 7/00

(52) U.S. Cl. 707/101

(57) ABSTRACT

In one form, the disclosure relates to data analysis, namely (but not exclusively) analysis of data in an analytical database. The disclosure may also relate to analysis of complex coded data, in particular hierarchical data. A number of aspects of invention are disclosed, including, without limitation, the Storage of hierarchic data, a GUI representation of hierarchic data, hierarchic data convolution and devolution, cross tabulation of complex data, including a segment method, an offset method, a one-level method, and a segment matching method, and a grid construction generator for making hierarchic variables.

### RELATED APPLICATION

This application claims the priority under 35 U.S.C. §119 of Australian Provisional Application entitled “A Method and Apparatus for Improved Processing and Analysis of Complex Hierarchic Data” filed Oct. 17, 2005.

### FIELD OF INVENTION

The present disclosure relates to the field of data analysis. In one form, the disclosure relates to analysis of data in an analytical database. For example, the disclosure relates to analysis of complex coded data, in particular hierarchical data, as often found in survey responses.

### BACKGROUND

There are often difficulties in analysing more complex data. There are a number of techniques used in assigning numeric codes to pre-defined categories so that the process of tabulation can be reduced to counting the number of codes. Furthermore, filtering and weighting are employed in using tabulation as an analytical tool. Simple data is relatively well handled but the handling of complex data—multi-response, incremented and/or, in particular, hierarchical becomes quite difficult. Although various techniques have been used, they often fail to address problems in the complexity of the data.

Data complexity may be discussed with reference to simple data, multi-response, incremented, hierarchical, for example.

Simple

For data such as Gender and Region, where the categories are mutually exclusive, the processing requirements for cross tabulation are relatively simple. It requires a count of the number of times each Gender code (such as 1=Females, 2=Males) and each Region code (such as 1=NE, 2=NW, 3=SE, 4=SW) occur in conjunction for a given case.

Multi-Response

Data on weather events, however, might be coded as:

c1=rain

c2=hail

c3=snow

c4=wind

c5=heat

A town may have none or all of these so a record for one town may be blank and for another town, with reference to the code above, it may be 1;2;3;4. Yet another town that has had several episodes of hail in one day may record 2;2;4;2 with reference to the code above.

Cross tabulating multi-response data requires iterating over all possible pair combinations.

Incremented

Each event may have an increment or value associated with it like the amount of rain, the speed of wind. This may be recorded as 1*30; 4*55 to mean 30 mm of rain and winds of 55 kph, using table 1 above. When tabulated, the specified increment for that instance of that code is added to the aggregate, instead of the default increment of 1.

Hierarchic

Complex data sets can often have a natural hierarchy. There are many examples:
Doctor/Patients/Prescriptions
Departments/Computers/Installed Software
Field trials for a pharmaceutical, Laboratory/Trial#/Test Type/Result
Market research of brand attributes ratings
etc.

This sort of data is notoriously hard to analyse. Obvious sorts of questions a researcher might want answered, relative to the examples above, are:
How many prescriptions does each doctor issue? As a percentage of the number of patients? How many patients have more than one doctor? Of all issued prescriptions, what proportion are analgesics, antibiotics?
What is the ratio between the number of computers and the number of installed applications? Which departments have the most spreadsheets? How many applications are installed on a given OS, etc.
Which laboratories consistently get a pass for a particular test. Which don't? Which tests pass most often? Do the results for one trial differ substantially or significantly from others?
For a given set of branded products, and a set of attributes, how is each brand rated? For subsets of brands? Is one attribute more/less popular across all brands than others?

Hierarchic data contains information at several levels. Recording the severity of weather events at many towns involves, for example, three levels of coding. In addition to the event codes, the towns could be coded as 1,2,3 etc. and severity of the weather could be coded as 1,2,3 etc. This data is often pictured as a tree or set of trees as illustrated in FIG. 1.

It can be extrapolated that for 20 towns, 5 events and a severity scale of 10 there are potentially 1000 different data items to be recorded each day. Furthermore, data at each level of a hierarchic structure can itself be multi-response, incremented and/or simple uncoded quantities. To allow for multiple events of the same type usually involves multiplying the possibilities—2000, 3000, 5000—with tension arising between allowing for enough multiple events and not wasting too much space on data storage.

Hierarchic data for one case is essentially an N-node tree of any depth and complexity. Very few systems are considered to come close to storing this economically. RDBs (Relational DataBases) may use several linked tables, card image and other flat forms must provide space for every possible branch combination even though very few may be used.

Another difficulty is that, although commonly referred to as ‘trees’, what is really needed is a ‘forest’—a collection of trees. For survey data, the root node is often conceptual, comprising the variable itself. A common example in market research is brand/attribute/rating. For example:

Q12a. Please rate each of the following statements for each brand on a scale of 1 to 10, where ‘1’ means ‘do not agree’, and ‘10’ means ‘agree very much’.

TABLE 1

| | | |
|---|---|---|
| TimTams | Monte Carlo | Salada |

Is a healthy product
Good value for money
Has an excellent reputation
Available at many retail outlets

For a single respondent, the grid could be filled out as:

TABLE 2

| | TimTams | Monte Carlo | Salada |
|---|---|---|---|
| healthy product | 2 | 1 | 4 |
| Good value for money | 4 | 7 | 10 |
| Has an excellent reputation | 9 | 6 | 8 |
| Available at many retail outlets | 10 | 8 | 7 |

The tree representation, including the conceptual root, is illustrated in FIG. 2. There are many well-establish algorithms for reading such a tree, but for cross tabulation none are considered entirely satisfactory.

Cross Tabulation

One general problem is that cross tabulation algorithms to address issues noted above, especially across an entire hierarchy, are considered relatively slow, clumsy, inefficient and generally inadequate. For cross tabulation, traversal speed is an important factor. Using conventional methods of address pointers at each node to the child nodes, whether on disk or in RAM, can be CPU-intensive, and makes manually following the data chains through the tree for diagnostic and verification purposes cumbersome and difficult.

Relational Database (RDBM) systems in particular find it extremely difficult, if at all possible, to calculate a full set of possible percentages. Systems derived from a survey processing tradition are generally somewhat a little better at handling hierarchic data, but are still considered to incur a severe performance penalty when used in conjunction with complex data.

Preparation of hierarchic data for analysis by cross tabulation has usually been addressed by one of three methods:
1. Split the data up into many parallel variables, where the total number of variables equals the product of the number of categories at each level in the logical hierarchy. A problem with this technique is that there may be hundreds or even thousands of variables, which will often be sparsely populated, requiring individual cross tabulations for each, and the specification of a query on all the data will require each variable to be cited in some way, which can be physically difficult to achieve reliably.
2. Flatten the hierarchy by mapping each of all possible code combinations to a unique code of a new variable, where the number of new codes required is the product of the number of categories at each level in the logical hierarchy. It is considered that this just shifts the problem from needing huge numbers of variables to needing huge numbers of codes with little improvement in waste of space or time.
3. Store each level of the hierarchy as a single variable, delimited in some way so that the codes can be appropriately matched across the hierarchy at cross tabulation time. It is considered that this reduces the space and time wastage but still requires unnecessary duplication (each level must replicate the structure of its neighbour) and leaves the levels, that are logically part of a whole, unlinked. This requires some effort of bookkeeping on the part of the user and opens the risk of making invalid or meaningless juxtapositions.

Another potential problem is that analytical outputs across an entire hierarchy either cross tabulated in its own right or against another variable, which should be available easily and quickly, can take a long time to process, require a lot of manual checking, are hard to specify (could take many pages of SQL in the RDBM world) and are often hard to interpret.

Representation of Hierarchic Data

Representing conventional variables to a user is commonly done in a tree display showing the variable as a folder with its codes as children under the folder. Hierarchic data often present another problem in that there is no conventional way to present them. Unravelling all possible pathways through a data tree may lead to a combinatorial explosion.

Hierarchic Data Convolution and Devolution

In specifying tables with conventional data, there is typically a direct relationship between the codes in the specification and the rows and columns: every top code makes one column in the table and every side code makes one row in the table. Hierarchic variables present a problem because they are best represented as a tree structure for specification but the number of rows or columns is not simply related to the number of codes. A variable with three levels having 2, 2 and 5 codes respectively will generate 2×2×5=20 rows or columns. This is illustrated in FIG. 3.

The matter is further complicated by filter and weight expressions that can appear as an unlimited chain of parents of any variable. Additionally, codeframes may have base expressions that need to be preserved and a flag indicating which codes are to be based. This information also needs to be stored in files as saved tables in a way that both the row/column nesting and the specification tree can be reconstructed.

Grid Construction Generator for Making Hierarchic Variables

The use of hierarchic variables may be considered to be a good way to analyse data, but most data collection systems can't provide it. Usually the data is ‘atomised’. Data on records for 20 towns of 5 classes of weather event at 10 severity levels might arrive as 20*5=100 different variables each with a 1-10 code frame or, at worst, 1000 different binary variables. Organizing and representing this may be possible with certain traditional construction techniques, but is considered to be time consuming and difficult.

Any discussion of documents, devices, acts, or knowledge in this specification is included to explain the context of the ideas disclosed herein. It should not be taken as an admission that any of the material forms a part of the prior art base or the common general knowledge in the relevant art elsewhere on or before the priority date of the disclosure and claims herein.

### SUMMARY OF INVENTION

The present disclosure provides, in one aspect of invention, a data format and/or method of representing hierarchical data such as from a survey response, comprising a string of indicia, the string including indicators of tree depth (level).

The present disclosure provides, in a second aspect, an analytical tool adapted to provide analysis based on data formatted as herein disclosed.

The present disclosure provides, in a third aspect, a GUI representable data format and/or method of displaying hierarchical data, comprising at least one first folder, at least one second folder, the second folder being provided within the first folder, each second folder including code(s) related to a corresponding level of the hierarchy.

The present disclosure provides, in a fourth aspect, a data structure representation and/or method of representing the structure of hierarchical data, comprising the steps of providing a first folder representing a variable, providing at least one second folder, within the first folder, each second folder representing a level, and providing within each second folder, codes for that level.

The present disclosure provides, in a fifth aspect, a data representation and/or a method of converting data represented in a first format to data represented in a second format, comprising the step of using SRL in the process of converting the first format to the second format.

The present disclosure provides, in a sixth aspect, a cross-table specification represented in SRL.

The present disclosure provides, in a seventh aspect, a schema adapted to represent a cross table specification, comprising first indicia representing a variable and second indicia representing code(s).

The present disclosure provides, in an eighth aspect, a specification representation language as herein disclosed.

The present disclosure provides, in a ninth aspect, a method of processing data, the method comprising the steps of providing data representing a hierarchy having at least two levels, each level having at least one code and processing the data at each level as a single unit (segment).

The present disclosure provides, in a tenth aspect, a method of determining a row or column in a table applicable to a given response having a complex data structure, the method comprising the steps of determining the response, determining the structure of the variable, and processing the structure arithmetically to determine the row or column for the response.

The present disclosure provides, in an eleventh aspect, a method of processing a response, the method comprising the steps of determining the level, and processing a segment(s) only in that level.

The present disclosure provides, in a twelfth aspect, a method of accommodating a variable by providing segments equivalent to the segments at that level.

The present disclosure provides, in a thirteenth aspect, a method of arranging variables in a table configuration, the method comprising the steps of selecting the variable, providing a grid structure and slotting the variable into the grid at a desired location.

An object of the ideas in the present disclosure help enable data to be relatively transparent and/or relatively easier to present to an end user. A still further object may be to make the direct cross-tabulation of hierarchical data possible, relatively fast, relatively straightforward and/or relatively reliable. Other aspects and preferred aspects are disclosed in the specification and/or defined in the appended claims, forming a part of the description of the invention.

In essence, the present invention, with regard to the following aspects of invention:

1. Storage of Hierarchic Data
Provides a way of storing complex data that is highly space efficient and facilitates rapid processing. What would otherwise be stored in many files with indexing links is stored in a single file, one case per line. Multi-responses are separated by semi-colons. Increments are preceded by an asteric. Hierarchic tree structure is indicated with alphas for levels.

2. GUI Representation of Hierarchic Data
Provides a way of representing hierarchic data that conveys an intuitive understanding of the structure while avoiding the combinatorial explosion of possibilities. The hierarchic structure, which would otherwise be inferred by linked tables or other devices requiring some effort to interpret, is indicated as a tree with Levels as child branches having their codes underneath.

3. Hierarchic Data Convolution and Devolution
Provides a manner of employing a Specification Representation Language that effectively mediates between the intuitive GUI representation of hierarchic variables, the combinatorial explosion of rows and columns on resulting tables and the storage and retrieval of this information in files.

4. Cross-Tabulation of Complex Data
a) The segment method.
   Provides an approach to defining the unit of data that facilitates processing complex data. Rather than regard a single code as the unit, a segment is all the responses at one level point—effectively one node of a tree of data—and may be just a single code but could be many codes each with increments. The approach to the data is from a different perspective that allows economies of speed and simplicity. For example, by using a larger unit of data, the complexities of multi-response and incremented data have been found to be segregated and relatively easier to deal with.
b) The offset method.
   Provides a very fast arithmetic way of indexing hierarchical data elements that nonetheless allows for multi-responses at any level.

This is much faster than following links across tables or similar devices required of other storage techniques and is possible because the data from all levels is stored in the one place.
c) The one-level method.
   Provides a method that increases the efficiency of processing hierarchical data by establishing a ‘processing level’ and ignoring data at any other level.
d) The segment matching method
   Provides a way of preparing responses from different variables to facilitate rapid processing. During processing, variables may contribute to the top, side, filter and weight components of a table specification. A relatively fast way to process the responses for a particular case is if all components have the same number of segments. This preparation arranges for that even if the four components are all hierarchic and all at different levels. This method enables expanding or collapsing of segments at one level to substantially match the number of segments at another level. The result is at each level, an array of substantially the same length, with data related by parallel indices rather than tree navigation. Effectively, it converts a filter and/or weight result at one level to the equivalent result at another level by referring to the tree structure implicit in the actual response string.

5. Grid Construction Generator for Making Hierarchic Variables
Provides a method for combining the combinatorial explosion of simple variables that logically form a structured hierarchic variable. In particular, an intuitive visual way of building the single hierarchic variable from a profusion of simple ones.

The systems and methods described herein may result in any number of advantages, such as:
i. enables hierarchic structures comprising any mix of data types to be tabulated and cross-tabulated under most, if not any, filter and/or weighting condition in a way that is highly computationally efficient;
ii. produces cross tabulations that are considered functionally complete, in that all logical outputs with respect to any combination of one, some or all hierarchic levels, can be easily obtained, whether within the hierarchy itself, or within a cross tabulation of the complete hierarchy or any one of its levels by any other variable;
iii. can ‘unloop on the fly’ meaning many, even thousands, of tabulations can be reduced to one;
iv. hierarchic data that is often stored in many, even thousands, of variables can be stored in a reduced number, even one;
v. specifications (including filtering, weighting and basing conditions) can be expansive;
vi. speed of processing is increased;
vii. it becomes reasonable to generate the entire hierarchic table where previously this was too cumbersome, and to process the table speedily given the various inventive methods as herein disclosed;
viii. economy of storage and specification is improved;
ix. the data is relatively simpler to handle and interpret;
x. greater productivity is achieved with less knowledge required in using the present invention;
xi. fewer computational resources are required to use the present invention whilst still enabling the handling of relatively complex data; and
xii. hierarchic variables can be safely and easily assembled from a multitude of component variables.

Further scope of applicability will become apparent from the detailed description given hereinafter. However, it should be understood that the detailed description and specific examples, while indicating certain embodiments, are given by way of illustration only, since various changes and modifications within the spirit and scope of the present disclosure will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative, and in which:

FIG. 1 illustrates a representation of data;

FIG. 2 illustrates a tree representation of a market research survey response;

FIG. 3 illustrates a data tree;

FIG. 4 illustrates a hierarchical tree representation in accordance with an aspect of invention;

FIGS. 5, 6 and 7 illustrate how the SRL is used in accordance with an aspect of invention;

FIG. 8a illustrates a process of convolution according to an aspect of invention;

FIG. 8b illustrates a process of devolution according to an aspect of invention;

FIG. 9 illustrates an offset method according to an aspect of invention;

FIGS. 10a and 10b illustrate a one-level method according to an aspect of invention;

FIGS. 11a, 11b and 11c illustrate the segment matching according to an aspect of invention;

FIG. 12a and 12b illustrate filtering at different levels according to an aspect of invention;

FIG. 13 illustrates an example of grid construction according to an aspect of invention;

FIGS. 14 to 19 illustrate grid construction associated with each row or column being one variable; and

FIGS. 20 to 23 illustrate grid construction associated with each cell being one variable.

### DETAILED DESCRIPTION

Broadly, systems and methods by implement a number of aspects described herein, at least some of which are:

1. Storage of Hierarchic Data;

2. GUI Representation of Hierarchic Data;

3. Hierarchic Data Convolution and Devolution;

4. Cross-Tabulation of Complex Data
a) The segment method;
b) The offset method;
c) The one-level method;
d) The segment matching method.

5. Grid Construction Generator for Making Hierarchic Variables.

1. Storage of Hierarchic Data

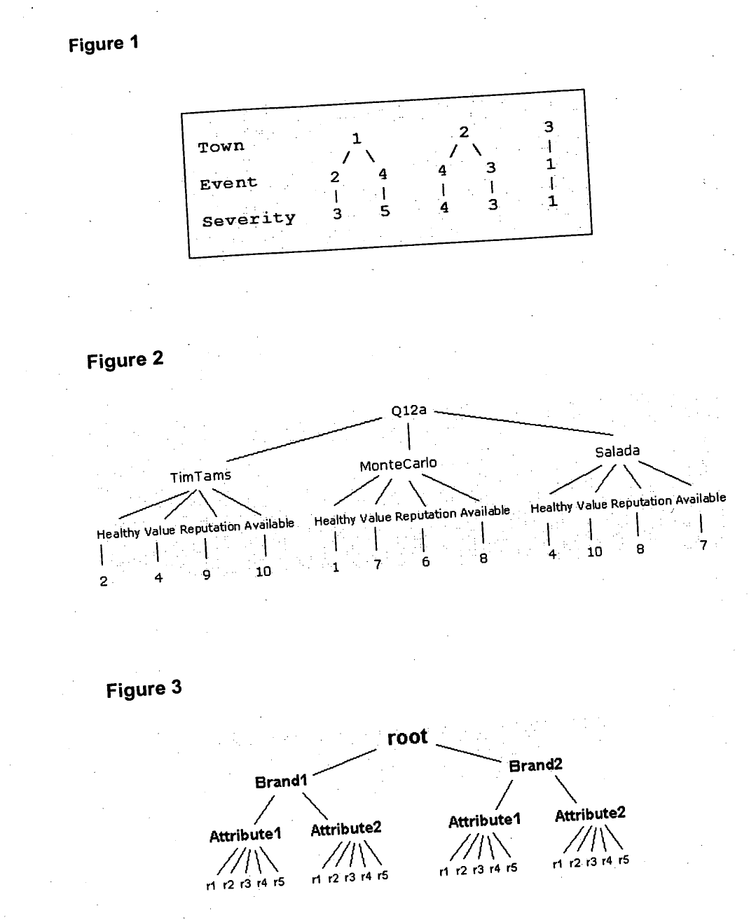

The data tree illustrated in FIG. 1 has three individual trees, one for each day in a weather database. FIG. 2 shows similar survey data with the three trees (one for each brand) as branches of a single question. In accordance with this aspect of invention, in general, tree depth indicators are used to store a forest of N-node trees in a string. Using alphas is a convenience, however, any indicia and/or format may be used. If more than 26 levels are needed, case sensitivity can be used to allow 52 levels. If more than 52 levels are needed, wide strings could be used (16 bit characters). If unlimited levels are required, then depth could be indicated by some such system as {1} . . . {2} . . . {3} . . . {4} . . . etc.

Thus, the information as illustrated in FIG. 1 may be stored as a single string, namely:
a1b1c2b2c4b3c9b4c10a2b1c1b2c7b3c6b4c8a3b1c4b2c10b3c8b4c7 string 1

where

‘a’ indicates product (TimTams, Monte Carlo, Salada),

‘b’ indicates one of health, value, reputation, available, and

‘c’ indicates value (response answer).

The items of rating data may be shown in bold (as above). The three brands at the top level are indicated by a1 . . . a2 . . . a3. Within each brand the four statements, at the second level, are indicated as a1b1 . . . b2 . . . b3 . . . b4 . . . a2 . . . . Within each statement the actual ratings, at the third level, are indicated as
a1b1c2b2c4b3c9b4c10a2b1c1 . . . etc. string 2

This representation of the data allows the entire tree to be traversed from left to right in a single pass.

The weather data from FIG. 1 may be recorded or stored as:
a1b2c3b4c5a2b4c4b3c3a3b1c1 string 3

where the letters indicate level (a, b, c . . . ) and the numbers are the data at each node.

Multi-response data is easily accommodated by using a semicolon delimiter (or any other indicia), for example:
a1b2c3;5 string 4

shows town 1 had two event 2s, of severity 3 and 5.

Incremented or value data is easily accommodated by using a preceding asteric (or any other indicia), namely:
a1b2c3*55;5*73 string 5

Thus string 5 illustrates town 1 had a weather event 2 with details 3 and 5 with associated measurements of 55 and 73, such as a storm (code 2 at level b) with 55 mm of rain (where rain is code 3 at level c) and 73 kph winds (where wind is code 5 at level c)

2. Representation of Hierarchic Data

There is a problem as noted above in representing a tree, such as (but for illustrative purposes only) the tree shown in FIG. 3.

In accordance with this aspect of invention, we represent:

i. a tree whose root folder represents the variable

ii. sub folders represents levels in order

iii. contents of sub folders are the codes at that level

FIG. 5 illustrates this, in which a hierarchic variable is shown as a folder with sibling sub-folders for each of the levels, these sub-folders each have as children their own codes. This reflects the tree model for hierarchic data, implies that each level can be treated as an independent normal variable and assists in comprehending the structure of the data.

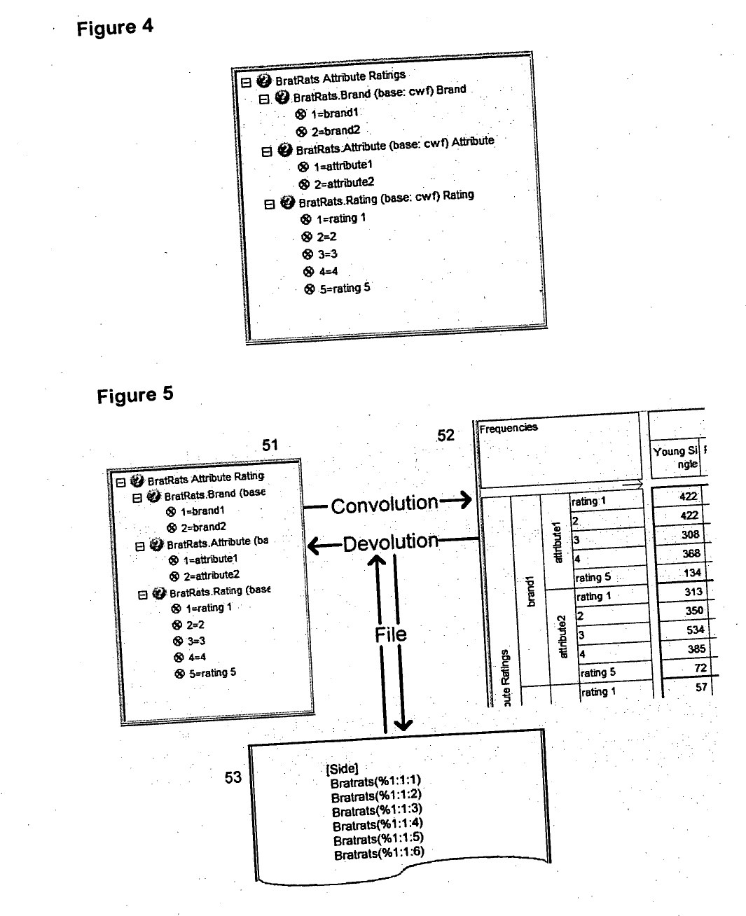

The GUI representation of FIG. 4 is considered to fully describe the tree of FIG. 3. Furthermore, the representation of FIG. 4 gives access for specification purposes to the entire variable (the root), each of the three levels (.Brand, Attribute, Rating), and each of the 2*2*5=20 possible paths. The advantage of this representation is that, if the levels comprised 10 codes each, creating 1,000 possible paths, only 30 leaf nodes need to be displayed for user-selection purposes. The representation in accordance with this aspect of invention has zero redundancy. For example, in FIG. 3, Attribute1 has to appear twice in the diagram—this is considered redundant. At the bottom level r1 appears four times. With deeper trees and more branches the redundancy gets worse.

The representation in accordance with this aspect may be referred to as a ‘cross-tab specification’.

3. Hierarchic Data Convolution and Devolution

Further to the above, the cross-tab specification may be represented in the form of a Specification Representation Language (SRL). The SRL may be used to correlate data between the ‘cross-tab specification’ style display of variables/levels/codes and a ‘table’ style display of rows/columns.

FIG. 5 illustrates how SRL is used in accordance with an aspect of invention. The cross-table specification 51 can be represented as a table via a process of ‘convolution’, and a table 52 may be represented as a cross-table specification 51 through a process called ‘devolution’. The convolution and devolution is enable through the SRL 53, which is saved, for example as a file or in memory.

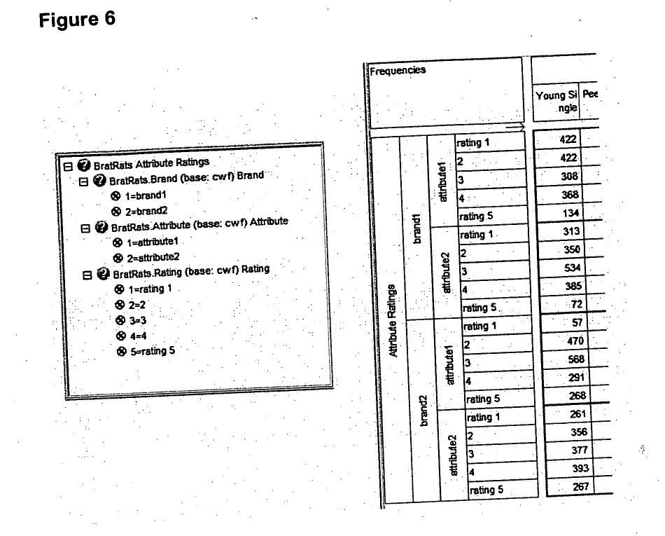

FIG. 6 provides a further illustration of this aspect. A variable (for example as shown in FIG. 4/5) with three levels having 2, 2 and 5 codes respectively will generate via convolution a table having 2×2×5=20 rows or columns. To respecify the table the 20 rows have to be disassembled and the tree structure reassembled. This is called ‘devolution’.

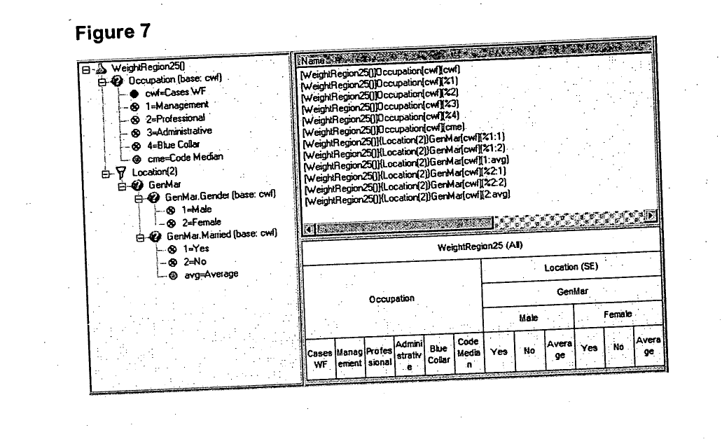

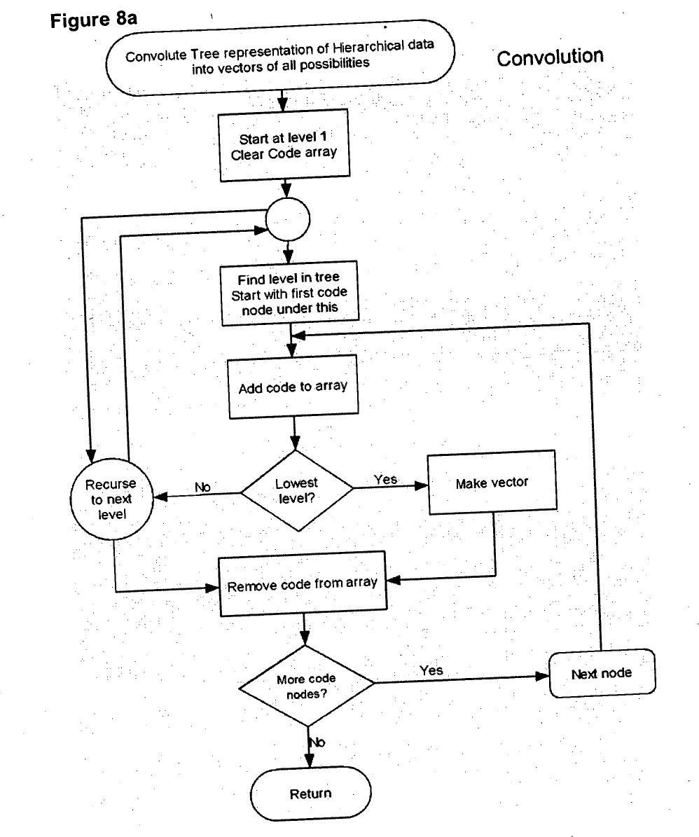

FIG. 7 illustrates SRL. The SRL is provided as a text representation of the full branch for each row/column, and that can be used to reassemble the tree with a ‘recursive devolution’ algorithm. FIG. 7 illustrates a specification on the left represented as a tree with filters, weights, variables, codes, bases and stats—some with percentages (circles with % in) and some not (other circles).

The SRL is a text string that substantially describes a row/column vector in a table in a way that also preserves the branching information from the tree representation of the table specification.

The general form of the lines is:
{xxx}[yyy] . . . var[base](% code) string 6

where

xxx and yyy are one filter and weight respectively in a modifying prefix before the variable

var is the variable or codeframe whose codes are being tabulated

base is an expression indicating how the numbers will be percentaged

code is the code number or other reference being shown in this row/column with the presence of a % sign meaning this row/column can be percentaged.

Some example lines:

[WeightRegion25( )]Occupation[cwf](cwf)

[WeightRegion25( )]Occupation[cwf](% 1)

[WeightRegion25( )]{Location(2)}GenMar(% 1:1)

[WeightRegion25( )]{Location(2)}GenMar(1:avg)

The lines can be assembled manually by reading the branch path down to any leaf node in a specification tree. Filters are written inside {} braces, weights in [] braces. These are the early nodes of a specification and represent a modifying prefix before the variable/code information is met.

For example the prefix {Gender(1)}[WeightRegion25( )] means that the first node in this path at the root of the tree was a filter Gender(1) and subordinate to that was a weight node WeightRegion25( ). There can be any number of these in any order.

The only unbracketed element of the line is the variable reference that immediately follows the modifying prefix. This may be a simple variable, and to distinguish from hierarchic variables is here called just a codeframe, or it could be a hierarchic variable.

Codes for simple variables are generally the code number but can also be any of two dozen mnemonics like ‘tot’ for total, ‘avg’ for average and ‘cwf’ for the cases-weighted-filtered base count.

Codes for hierarchic variables are the same elements (code numbers or 25 mnemonics) but now one for each level of the variable separated by colons.

In FIG. 7, at the Top right is the SRL, shown here as a text representation of the convoluted form of this tree as it is stored in files. Introductory filters are in {}, introductory weights in []. A base expression is in [] immediately after the variable name. Hierarchic codes are indicated with the colon-separator syntax. The flag indicating codes to be based is a % as the first thing inside the code bracket. All rows begin [WeightRegion25( )] meaning a weight node that is parent to all others. The last six rows continue with {Location(2)} meaning a filter node parent to all the GenMar nodes. The first 6 rows continue with Occupation[cwf] meaning a codeframe (simple variable in this case) using cwf as a base. Although specific indicia and/or formats have been used in this SRL, it is used by way of example only and the SRL may use any indicia and/or format without departing from this aspect of invention.

Thus, in the example illustrated in FIG. 7,

[WeightRegion25( )]Occupation[cwf](cwf)=plot cwf code not percentaged

[WeightRegion25( )]Occupation[cwf](% 1)=plot code 1 percentaged

[WeightRegion25( )]{Location(2)}GenMar(% 1:1) shows hierarchic node 1:1 meaning Gender(1)=Male and Married(1)=Yes

[WeightRegion25( )]{Location(2)}GenMar(1 avg) shows hierarchic node 2:avg meaning Female Average.

From this example, it can be seen that each line of the SRL represents a description of a row in the table that is also a description of its path from root to leaf in a tree representation like FIG. 3. Further, the collection of SRL lines can be ‘devolved’ to produce the specification version of the data tree as in FIG. 4.

The SRL may be stored and used as required in a convolution and/or devolution process.

In FIG. 7, in the bottom right, this information can be seen on screen as the convoluted tree structure where the hierarchic variable has been expanded.

Specification trees may also include function expressions. These are stored with an introductory @ and can be isolated or under codeframes.

{flt(1)}[weight( )]@expression

{flt(1)}[weight( )]var[base](@expression)

This aspect may enable the conversion between a Table Axis Specification Tree into a list of Table row/column vectors as shown in FIG. 7. The critical part of the vector for this description is the Specification Representation Language lines that substantially completely describes the row/column vectors and is used for saving to file. The Convolution/Devolution method is embedded in tree-walking and tree-generation algorithms.

Generating Vectors from a Specification Tree

The forward process takes a specification tree and generates the vectors that are the rows or columns of a table. Each of these is completely described by a SRL line.

The main driving function, GenerateVectors( ), is a recursive routine that starts at the top of the tree gathering nodes until it reaches particular nodes that provoke the generation of vectors, then backs up to the parent of the node.

Nodes collected along the way are Filter and Weight nodes. These are the early branches of a tree and are followed by vector-generating nodes. When a vector-generating node is reached the collection of filter/weight nodes represents the filter/weight prefix in the SRL line.

Nodes that generate vectors are:

Function—generate a single vector for this function

Codeframe—generate a vector for each child node of the codeframe

Variable—generate the convolution of hierarchic levels

The last of these is another recursive function GenerateVariableVectors( ) that walks down the Tree Representation of Hierarchic Data multiplying out all the possible combinations. This implements the Convolution algorithm.

Generating a Specification Tree from Vectors

The reverse process takes SRL lines that may have been loaded from file or delivered from a displayed table and rebuilds the specification tree.

The main driving function, ReadVectorBlock( ), is a recursive routine that walks along the bank of SRL lines from the supplied vectors looking for common prefixes. Any contiguous set of vectors with a common prefix is identified as a block and the routine is called again to look for subsequent common continuations of the prefix within the block. Each block, of course, represents an early node in the specification tree. Identification of blocks within blocks is the essential business of the routine, each block generating one intermediate node on the specification tree.

At the end of the SRL lines are codes and functions that will be the leaf nodes in the tree. Functions and simple codes are easily dealt with, generating a single leaf node each, but hierarchic variable nodes that are recorded like (3:2:4) are collected for processing by another recursive function that generates the Tree Representation of Hierarchic Data from the multitude of expanded lines. This implements the Devolution method.

Convolution Method

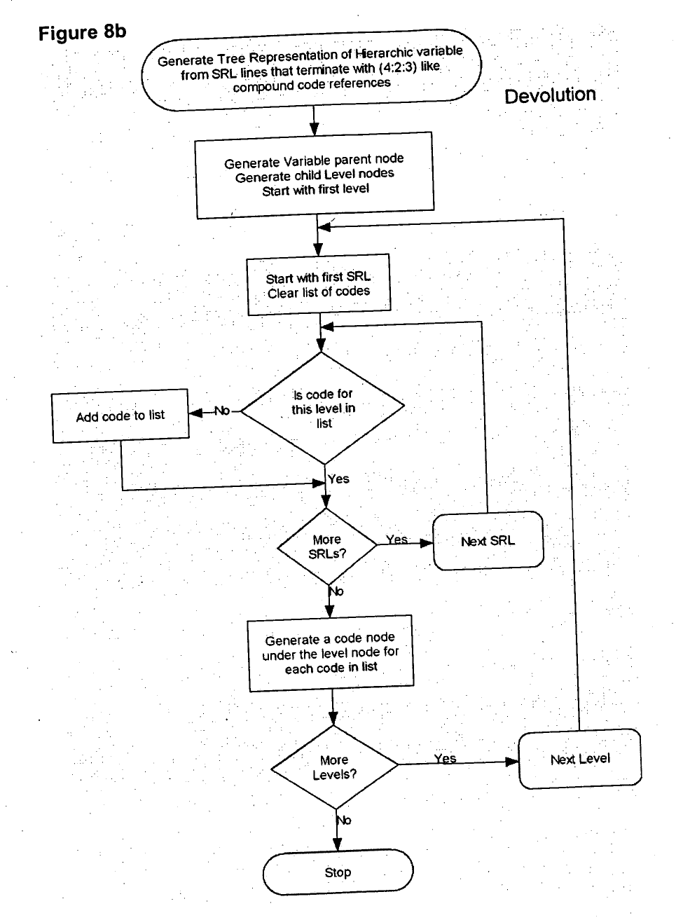

This takes the Tree Representation of Hierarchic Data and generates a vector for each of the multiplied possibilities. It looks for a particular level, starting with the first, and processes the code lines found underneath. These could be all or some of the available codes at this level and could include pseudo-codes that represent statistics like total and average or bases. Refer to FIG. 8a, which illustrates an example of the convolution method according to an aspect of invention. In processing a code, if it is not working at the lowest level the routine is called again to start at the next level down. This way, each code is combined with every code at the next level down, they being combined with every code at the next level down again ad infinitum until the lowest level is reached. When processing codes at the lowest level it generates a vector for each then returns so that the cycle can begin again for the next code at the previous level.

Every time a code is processed its value is placed in the correct spot in an array that is used by the vector-generating routine to build the SRL line. The prefix of this has already been assembled and the final step is to write the codes currently in the array in the form (3:2:4) to complete the SRL.

Devolution Algorithm

FIG. 8b illustrates an example of the devolution method according to an aspect of invention. The devolution method takes a set of SRL lines and generates a Tree Representation of Hierarchic Data. The lines have already been processed to generate the tree up to the hierarchic data point and the block of lines presented to this algorithm all terminate with code references like (3:2:4).

It is understood the generated tree will have an introductory parent node for the variable under which will be a child node for each level. The present method determines which code nodes are added as children of the level nodes.

The method first assembles the skeleton of the variable—the parent node and child level nodes—then builds the codes for each level in turn. The method then inspects the set of terminal code references looking only at the codes for a particular level. Often, there will be duplication here so the method just notes which codes appear at all and then makes a code tree node for each of them in the order they were first met.

4. Cross-Tabulation of Complex Data
a) The segment method.
b) The offset method.
c) The one-level method.
d) The segment matching method

Cross-tabulations have a top and side variable and can also be filtered or weighted. For example, a table of Town by Event might be filtered to a particular Severity, a table of Age by Consumption might be filtered to a particular Year and weighted by Gender to ensure a balance of respondents.

Handling complex data here presents many problems: the four 20 components of a specification (top, side, filter, weight) may be at different levels from hierarchic variables, and may be multi-response and/or incremented. The invention includes several cooperating methods to make it possible to handle all such variation in data.

a) The Segment Method.

Other prior art systems generally treat one code response as the basic datum. In the approach of this aspect of invention data like a1;2b3;4c5;6 is treated as three data items called segments. The first segment is a1;2, the second b3;4 and the third c5;6. The segments can also include increments so c3*30;4*55 is also just one segment. Organised as a data tree to show the hierarchy, the unincremented data is

Town: 1;2
Event: 3;4
   Severity: 5;6

A segment can also be thought of as a node of a data tree.

This device has made it possible to achieve efficient cross tabulation and other processing of this sort of data regardless of complexity.

b) The Offset Method

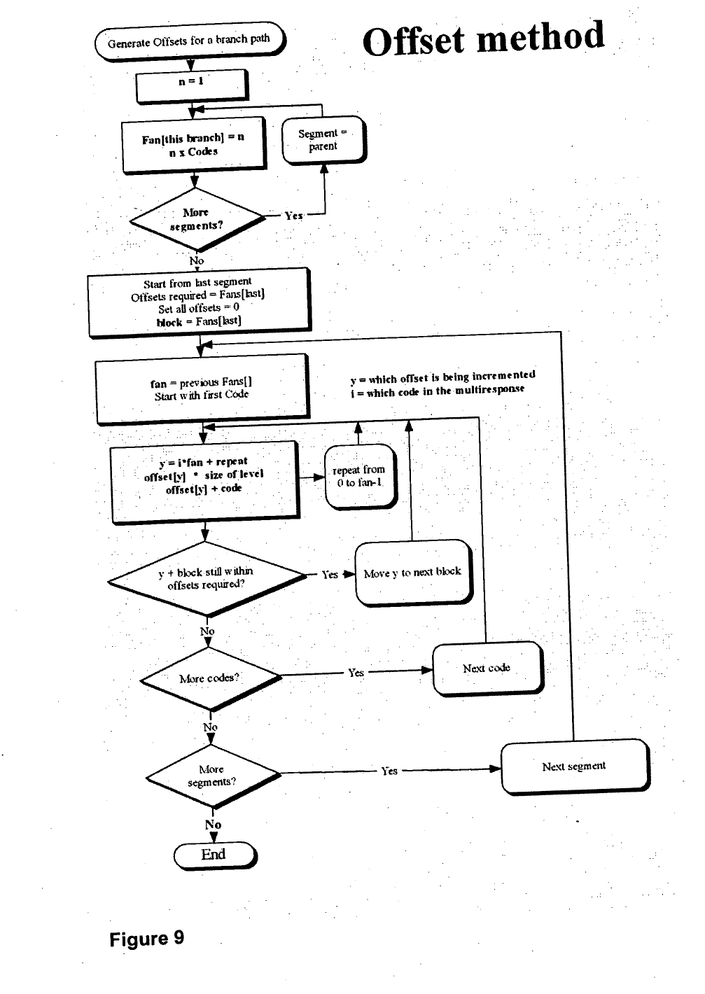

FIG. 9 illustrates an offset method according to an aspect of invention. The fundamental process in cross tabulation is determining in which cell of the table to store the data for the current case. The response in the across variable may be a code 4 (column index 3) and the side variable a code 6 (row index 5). If the side response is multi like 6;8;11 then three rows are involved. This is for simple data but of course the matter is more complicated for hierarchic data.

Note on INDEX, there is always a tension between enumerating things as a human prefers (1,2,3,4 . . . ) and as a computer prefers (0,1,2,3 . . . ). In a preferred embodiment, Index means zero-based systems. The first row will be at index zero in an array, the fourth row at index 3. This is why in the examples code a4 turns into a 3 in the calculations. The offsets calculated are also indexes so an offset of 4 means the fifth row.

When an entire hierarchic variable is involved, and because speed is 20 paramount, the offset method is made more complicated because it manages two streams of calculations both involving tree structures.

The kernel is the calculation of the offset itself from a hierarchic branch.

For example the offset for the response a4b5c6, the sixth line in the fifth block of the fourth major block, could be calculated arithmetically as (((3×Nb)+4)×Nc)+5 where Nb and Nc are the number of codes at level b and c.

The algorithm assembles these calculations in a way that is fast and allows for unlimited levels. The principle device is that each layer of parentheses is built on the previous in two steps:

multiply offset by size of this level

add response code-1 at this level

Starting from zero the layers are built like this:
offset=0
offset=offset×Na+3
offset=offset×Nb+4
offset=offset×Nc+5

Since multi-responses are allowed at any level a single response can generate many offsets. For speed these are all built up in parallel and keeping track of which offset is being worked on represents the second stream of calculation. The terms ‘fan’ and ‘block’ are employed here.

Fan and Block

In the example response a1;2b3;4;5c6;7;8 each of the segments is multi-response and the set will generate 2×3×3 offsets.

The 18 offsets are arranged in a particular order giving rise to terms used in the algorithm. The first offset is for a1, b3, c6 etc.

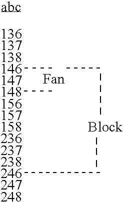

Considering the second code in the second segment: b4. When it appears it is in a ‘fan’ of three offsets and it next appears a ‘block’ of nine offsets later. The fan and block numbers for each level are:

| | | | |
|---|---|---|---|
| Fan | 9 | 3 | 1 |
| | a1; 2 | b3; 4; 5 | c6; 7; 8 |
| Block | 18 | 9 | 3 |

These numbers are clearly generated by progressively multiplying the number of codes at each level starting with 1. The fan size for one segment is the block size of the next.

In the algorithm these numbers are first generated and stored in an array to facilitate fast processing.

The rest of the algorithm is a nest of loops for each segment, each code, each fan and each block. All offsets are built progressively in parallel. The segment (level) and code contribute to the first stream of calculation using “times size of level, plus code index at this level”. The fan and block numbers contribute to the second stream of calculation keeping track of which offset is being updated.

c) The One Level Method

A hierarchic variable with three levels Town, Event, Severity might have a response stored as a4b2c4b3c5c6a1;2b3;4c8c5;6b7c9a3b2c1c5c7. In processing this to produce cross-tabs there may be a top or side variable just the Towns, just the Events, just the Severity or the entire variable (all details down to Severity).

In determining the offsets (rows/columns) at which to store data, every segment of data in the string may be considered because a4b2c4 refers to a different row than a5b2c4. Because of the other cooperating methods, this is not usually necessary.

It is only necessary to send to the offset routine segments of the required level. All segments not at the required level can be ignored.

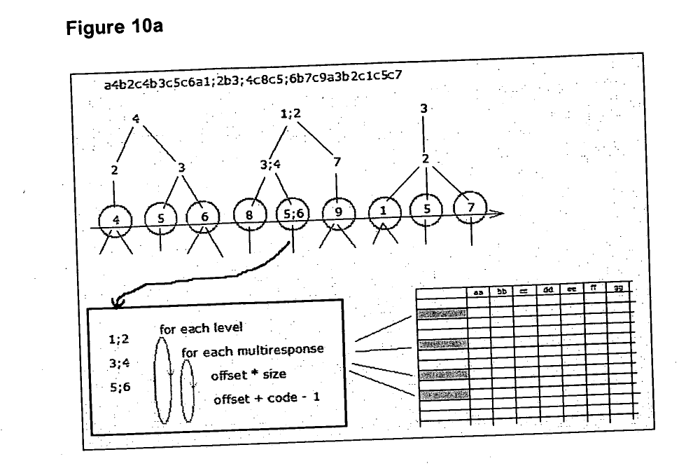

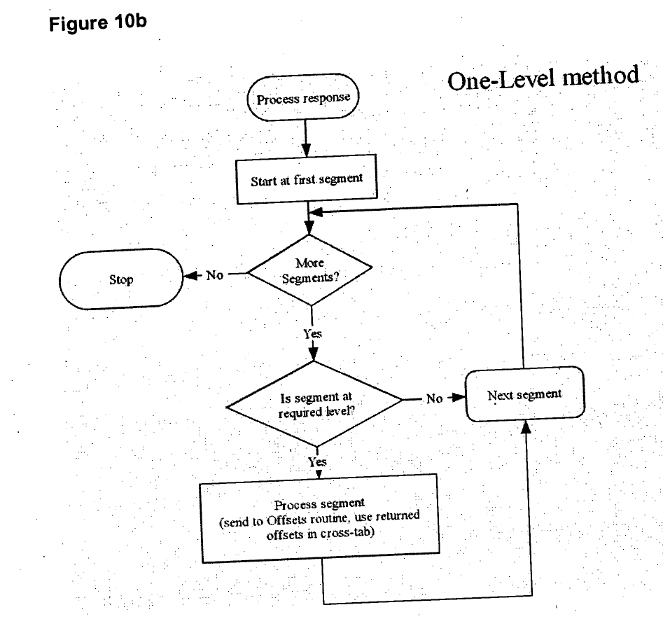

For instance, when an entire hierarchic variable is used the offset routine only needs the leaf nodes because it generates the branch back to the root itself and uses that to calculate the offsets. This is illustrated in FIG. 10a.

The response a4b2c4b3c5c6a1;2b3;4c8c5;6b7c9a3b2c1c5c7 arrives at 5 the processing functions divided into seventeen segments (some multi-response) a4 b2 c4 b3 c5 c6 a1;2 b3;4 c8 c5;6 b7 c9 a3 b2 c1 c5 c7.

The One-level method simply scans these sending to the Offset routine only those at the required level. FIG. 10b illustrates this.

d) The Segment Matching Method

Cross tabulation proceeds by determining in which cell of the table to store the data for the current case. This seems logical for simple data but for complex data that may have many segments the interaction between the segments in the four components of the specification (top, side, filter, weight) needs management.

For instance, for the data shown in FIG. 1, if the table is Town by Event then Town has three segments a1 . . . a2 . . . a3 and Event has five segments . . . b2 . . . b4 . . . b4 . . . b3 . . . b1. In fact, as FIG. 1 shows, the a1 node matches the first two b2 . . . b4 nodes but the last . . . a3 node matches only the single last . . . b1 node—but this is not at all obvious from the independent strings.

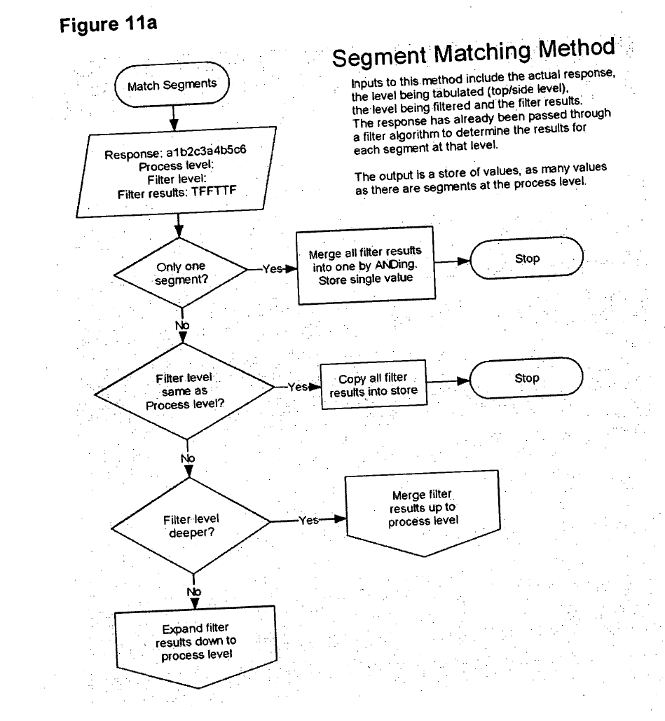

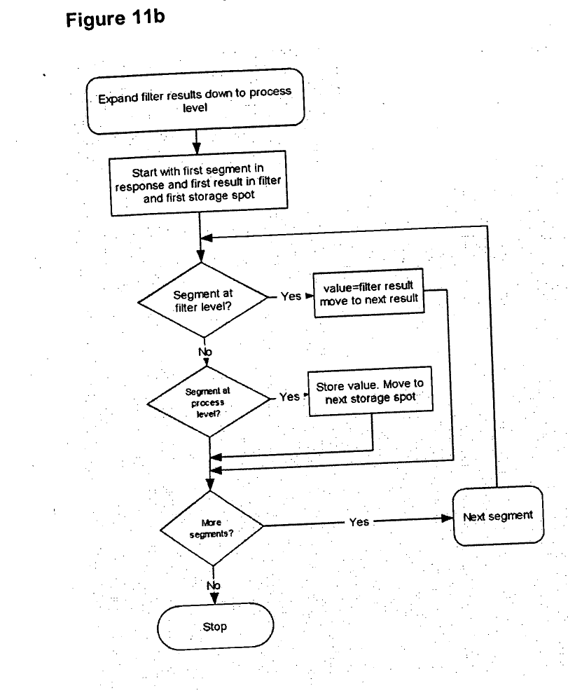

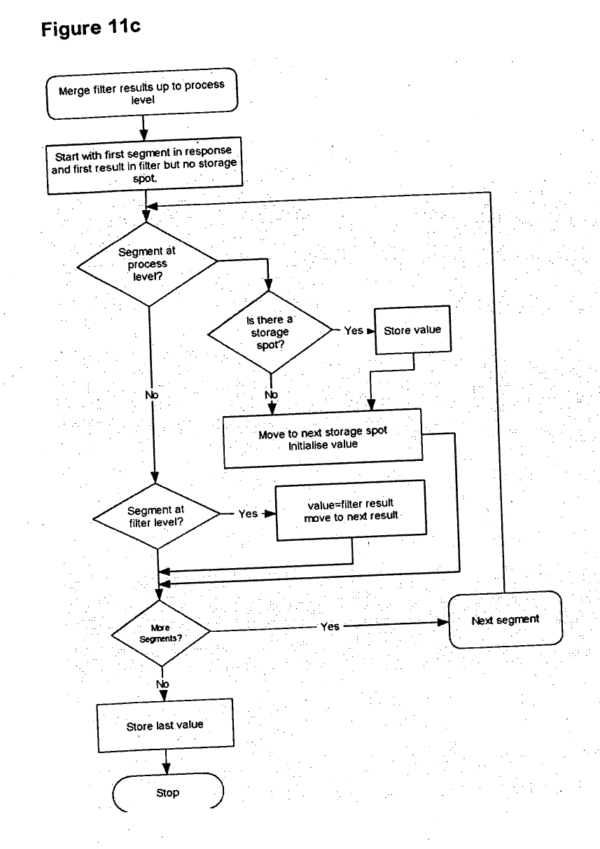

The segment matching method according to this aspect of invention, and as illustrated in FIGS. 11a, 11b and 11c, is a preparation step in processing the data for one case that collapses and expands segments so that each of the four components has data all with the same number of segments. Processing (where top and side segments are sent to the offset routines to determine in which cells to store data) is then a matter of stepping through the segments in all four components in concert.

Matching up the above ‘a’ and ‘b’ segments might mean expanding the ‘a’s so both strings have five segments:

| | | | | |
|---|---|---|---|---|
| a1 | a1 | a2 | a2 | a3 |
| b2 | b4 | b4 | b3 | b1 |

This preparation is a relatively complicated step but the time it costs is relatively small compared to the time saved in the subsequent processing step. Additionally, it relieves the processing step of another layer of tree navigation making that routine not only faster but easier to design.

Simple data only ever has one segment, even if multi-response or incremented, because simple variables only have one level. Hierarchic data can have many segments so when it appears in any of top, side, filter or weight, the segments must match at the required level to have meaning.

A simple variable always matches anything, the single segment being duplicated as much as required to meet a multi-segment response.

i) Process Level

The first step in preparation is to determine a single level to which all four components (top, side, filter, weight) will be aligned.

The top and side variables may be simple (level a) or a single level from a hierarchic variable. If the entire variable is processed it is regarded as being the deepest level. The Process level is the minimum of the top and side levels. For example Town by Severity is processed at level a, Event by Severity at level b, Event by Town at level a.

Aligning the top and side components involves simply noting where the process level segments begin in the top and side responses. For the data to have meaning there must be the same number of these in top and side. Aligning filter and weight components involves additional considerations.

ii) Filtering at Different Levels

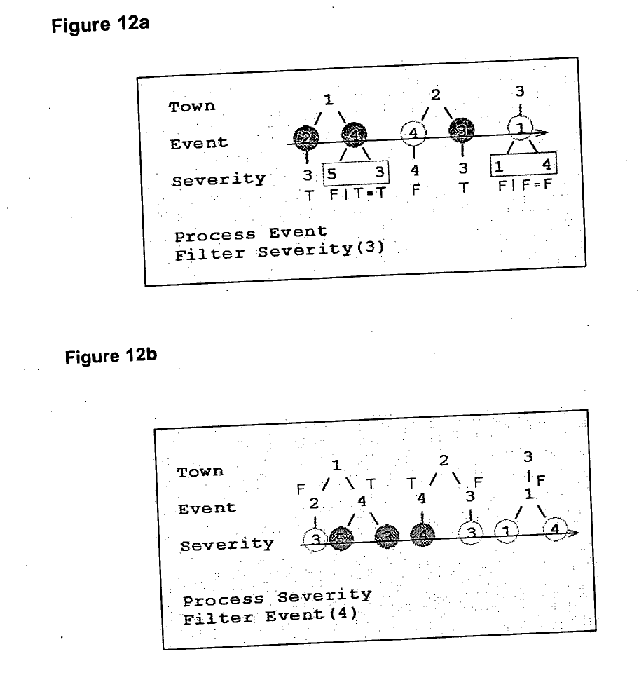

If the filter level is deeper than the process level, then a segment will pass the filter test if any child nodes at the filter level pass the test. For instance, from the data pictured in FIG. 12a, if the process level is b (Event) then we are interested in which segments at the Event level will make contributions to the table. If the table has the filter Severity(3), meaning ‘only show Events that were severity 3’, only those events that have a 3 as a child will pass.

The first event segment (2) has one child node that is severity 3 so it passes the test. The second event segment (4) has two child nodes and one of them is a 3 so it also passes the test. The last event segment (1) has two child nodes but neither is a 3 so it fails the test and is said to be ‘filtered out’.

When the filter level is shallower than the process level then all child nodes of successful filter nodes will contribute and all child nodes of failed filter nodes will be ‘filtered out’ and not appear in the table. For instance, from the data pictured in FIG. 12b, if the process level is c (Severity) then we are interested in which of the severity segments will appear in the table. If the table has a filter Event(4) it means ‘only show severity for events of type 4’.

The first event segment (2) fails the filter so its single child severity 3 is ignored. The second event segment (4) passes the filter so both its child severity nodes will contribute to the table.

The method that achieves this is shown as a flow chart of FIGS. 11a, 11b and 11c. The input to that algorithm is the process level, the filter level, the original response (for the above examples a1b2c3b4c5c3a2b4c4b3c3a3b1c1c4) and the filter results at the filter level (e.g. TFTFTFF for the first example). The output is the filter results matched to the process level. (TTFTF for the first example). Effectively, it converts a filter result at one level to the equivalent result at another level by referring to the tree structure implicit in the actual response string.

The method begins by considering the simple cases: a simple variable has only one segment so duplicate it to match segments at the process level; if the filter and process levels are the same they are already matched. Then it branches off to the more intricate routines for deeper and shallower filters.

A similar method is employed to collapse/expand weighting values at different levels.

5. Grid Construction Generator for Making Hierarchic Variables

This aspect often provides a visual way of assembling individual variables into a single grid or hierarchic variable. This aspect of invention may be used to convert relatively simple data which is somewhat repetitive into hierarchical data.

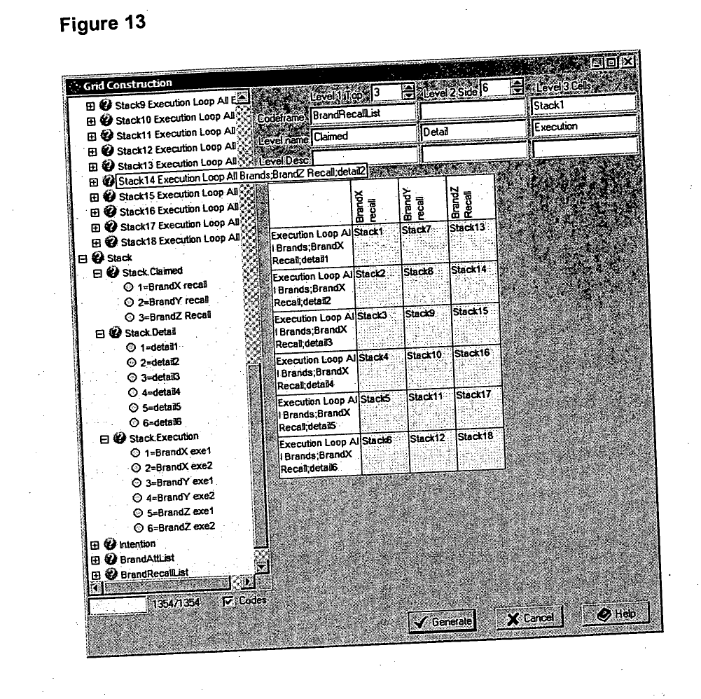

Referring to FIG. 13, the hierarchic variable named Stack is constructed from 18 simple variables by dropping them into the grid. The grid is sized and labelled by dropping some of these simple variables into edit fields at the top of the form. Clicking ‘Generate’ produces the 3×6×6=108 set of construction lines that, when run, build the hierarchic stack variable.

1:1:1=Stack1(1)

1:1:2=Stack1(2)

. . .

3:6:5=Stack18(5)

3:6:6=Stack18(6)

The benefit is in saving time and effort and in a visual device that makes the task intuitive.

The construction script is a fairly common device, each line meaning, “output a code on the left of the = whenever the data satisfies the filter condition on the right.” In normal circumstances the code would be just a single number and here they are obviously hierarchic.

In practice there are two preferred interpretations of the grid. The following indicates the actions taken to achieve each interpretation with a view to making clear the visual, intuitive character of the device. The generation is fairly standard once the meaning of the interpretations is clear.

The first interpretation is characterised by having nothing in the third level edit fields. This signal tells the program to generate filter expressions using the top or side variables supplied. The second interpretation is characterised by having a variable in the third level edit field. This signal tells the program to generate filter expressions from the variables in the cells.

In both interpretations the labels for the levels of the generated variable are automatically taken from component variables (either their description or code labels depending on context) saving a great deal of time and effort.

In essence, the device reduces a great deal of manual effort in which complexity, repetitiveness and sheer mass make fatigue and mistakes likely. The visual character also replaces the cognitive ordeal of maintaining command of a multitude of text lines, with an easily comprehendible visual metaphor.

5a. Each Row is One Variable or Each Column is One Variable

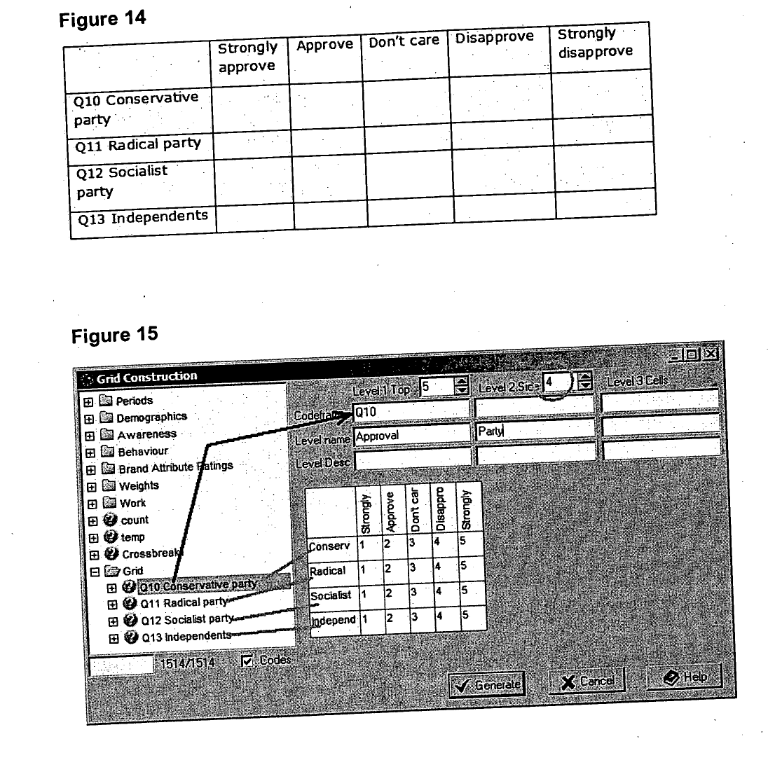

FIG. 14 shows four variables named Q10 to Q13 each with the same codeframe of five items from Strongly Approve to Strongly Disapprove. What you want is one hierarchic variable with the first level being Party and the second level Approval.

Referring to FIG. 15, firstly, drag Q10 into the Top Level Codeframe (dark blue). This will fill out the top cells with the labels from Q10's codeframe and set top cells to 5. Actually any of Q10-13 would do because the codeframe is all that is required.

Secondly, increase Side cells to 4 (pale blue circle) and drop each of Q10-13 in the side cells.

Change the Level Names to properly describe what's there—Approval and Party

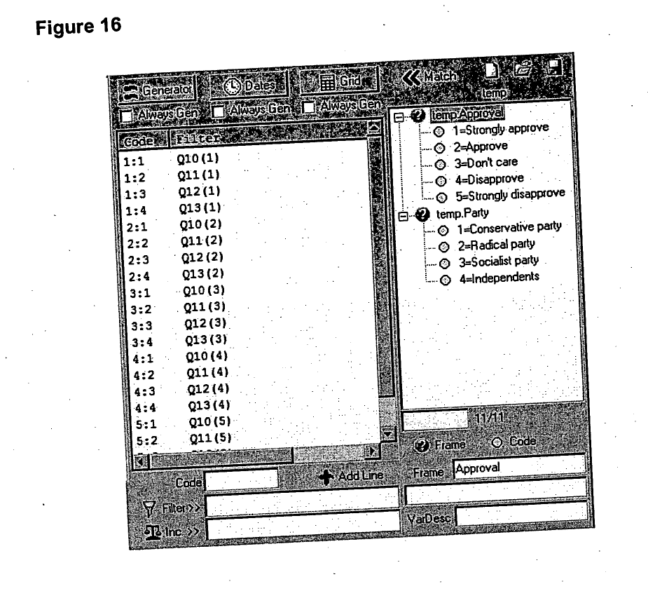

Clicking ‘Generate’ produces the script shown in FIG. 16.

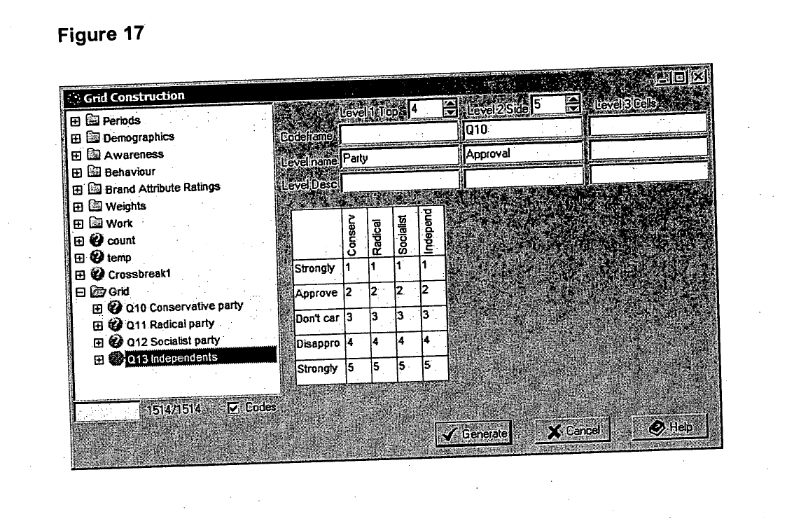

If, for example, it is decided that this is the wrong way round, and Party is to be the first level and Approval is to be the second, then click ‘Grid’ again and match the following as illustrated in FIG. 17. This shows you can reverse the orientation of the table to suit.

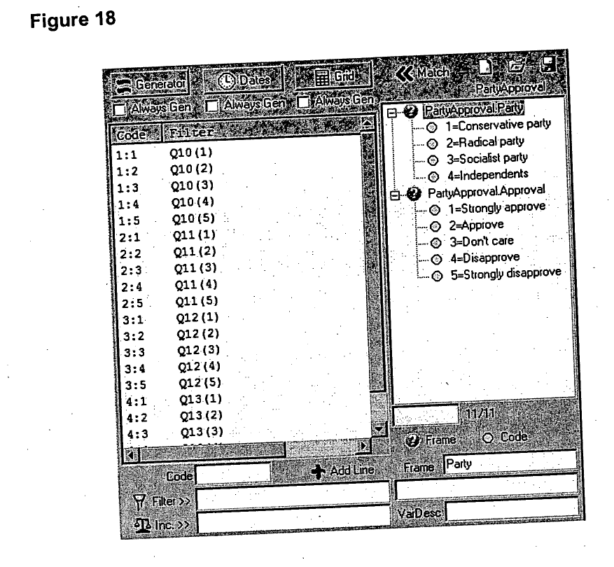

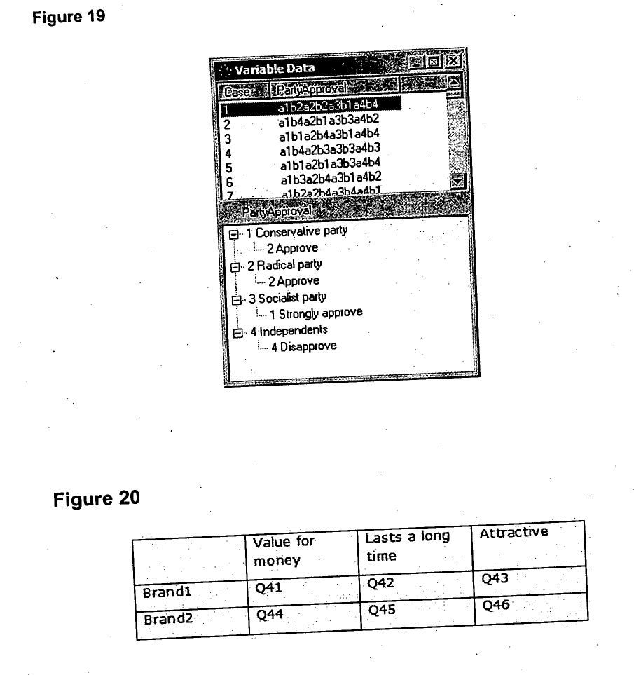

Clicking Generate gives FIG. 18. Note the filter expressions are built from the Side variables. When this script is run the data produced is shown in FIG. 19. The top panel shows the data for each case in its compact form and the lower panel shows the first case represented as a tree structure.

5b. Each Cell is One Variable

In highly atomised field systems where multi-response can't be stored, a grid question arises where each cell has been stored as a separate variable.

In the example shown in FIG. 20, Q41-46 hold the rating score given by respondents for two brands against three statements—how attractive is brand 1 etc.

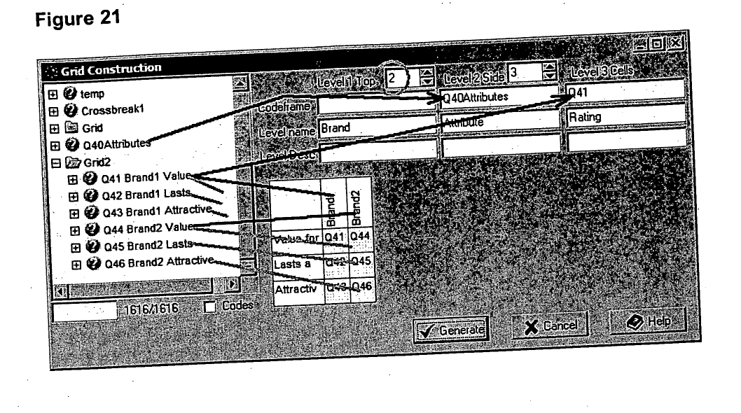

Referring to FIG. 21, firstly (dark blue), the variable Q40Attributes 30 dragged to the Side Codeframe field provides the labels for the side of the table (second level of the hierarchic variable being generated) and the variable Q41 dragged to the Cells Codeframe field provides the labels for the third level. Secondly (light blue), setting the Top Level to 2 codes establishes the size of the table and the variables Q41-46 are dragged into the cells as indicated. These provide the names for the filter expressions of the construction lines that will be generated. Thirdly (magenta), two variables dragged into the top cells provide the labels for the top of the table (first level of the hierarchic variable).

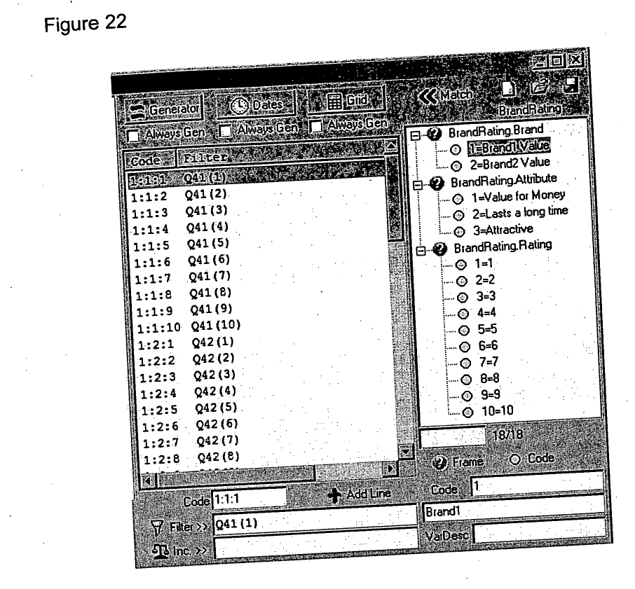

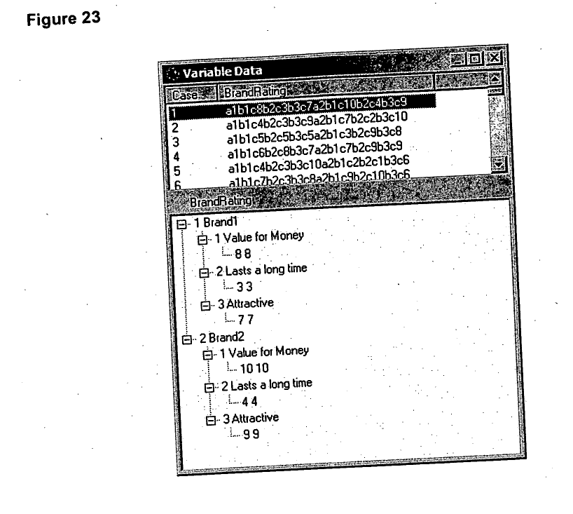

FIG. 22 shows the resulting construction script. Note the filter expressions are from the variables in the cells. FIG. 23 shows the data from the generated variable in its compact form and the first case shown as a tree structure.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. For example, It will be convenient to hereinafter describe the invention in relation to hierarchical data, however it should be appreciated that the present invention is not limited to that use only. In the following claims, means-plus-function clauses are intended to cover structures as performing the defined function and not only structural equivalents, but also equivalent structures.

“Comprises/comprising” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A data format adapted to represent hierarchical data such as from a survey response, comprising a string of indicia, the string including indicators of tree depth (level).

2. The data format as claimed in claim 1, wherein the indicators are provided for each level.

3. The data format as claimed in claim 1, wherein the indicators are represented by different indicia and/or indicia format.

4. The data format as claimed in claim 1, further comprising representing multi-response data by a delimiter.

5. The data format as claimed in claim 1, further comprising representing incremented data by a delimiter

6. The data format as claimed in claim 4, wherein the delimiter is represented by different indicia and/or indicia format.

7. The data format as claimed in claim 1, wherein the string is a single string.

8. An analytical tool adapted to provide analysis based on data formatted to represent hierarchical data such as from a survey response, comprising a string of indicia, the string including indicators of tree depth (level).

9. A GUI representable data format for displaying hierarchical data, comprising:
at least one first folder;
at least one second folder, the second folder being provided within the first folder; and
each second folder including code(s) related to a corresponding level of the hierarchy.

10. The data format as claimed in claim 9, wherein the order of the folders represents a hierarchical structure.

11. The data format as claimed in claim 9, wherein the first folder represents the root of the hierarchy, such as a variable.

12. The data format as claimed in claim 9, wherein the at least one second folder represents the levels, preferably in order.

13. The data format as claimed in claim 12, wherein the at least one second folder represents the levels in order.

14. The data format as claimed in claim 9, wherein the code is an attribute of the at least one second folder.

15. A method of representing the structure of hierarchical data, the method comprising the steps of:
providing a first folder representing a variable;
providing at least one second folder, within the first folder, each second folder representing a level; and
providing within each second folder, code(s) for that level.

16. The method as claimed in claim 15 further comprising the step of ordering the folders to represent the hierarchical structure.

17. A method of converting data represented in a first format to data represented in a second format, the method comprising the step of:
using the Specification Representation Language (SRL) in the process of converting the first format to the second format.

18. The method as claimed in claim 17, wherein the SRL is stored in a file.

19. A cross-table specification represented in SRL.

20. A schema adapted to represent a cross table specification, comprising:
first indicia representing a variable; and
second indicia representing code.

21. The schema as claimed in claim 20, further comprising any combination of:
third indicia representing weights;
fourth indicia representing filters;
fifth indicia representing hierarchical code;
sixth indicia representing flags; and
seventh indicia representing a base expression.

22. The schema as claimed in claim 20, wherein each line of the schema describes a row or column (of tabulated data).

23. The schema as claimed in claim 20, wherein each line of the schema describes a table specification node back to its root.

24. A specification representation language comprising a general form:
{xxx}[yyy] . . . var[base](% code)
where:
xxx and yyy are one filter and weight respectively in a modifying prefix before the variable;
var is the variable or codeframe whose codes are being tabled;
base is an expression indicating how the numbers will be percentaged; and
code is the code number or other reference being shown in this row/column with the presence of a % sign meaning this row/column can be percentaged.

25. A method of processing data, the method comprising the steps of:
providing data representing a hierarchy having at least two levels, each level commonly having at least one code; and
processing the data at each level as a single unit (segment).

26. The method as claimed in claim 25, wherein the data is survey data.

27. The method of determining a row or column in a table applicable to a response having a complex data structure, the method comprising the steps of:
determining a response;
determining a structure of a variable; and
processing a structure arithmetically to determine the row or column for the response.

28. The method as claimed in claim 27, wherein the processing comprises:
multiplying offset by size of a level; and
adding response code less one to the offset.

29. The method as claimed in claim 27, further comprising first initialising the offset to zero and then processing for each level of the structure.

30. A method of processing a response, the method comprising the steps of:
determining a level; and
processing only segments at that level.

31. The method as claimed in claim 30, further comprising:
determining a response;
determining a structure of a variable; and
processing a structure arithmetically to determine the row or column for the response.

32. The method as claimed in claim 30, further comprising the step of accommodating a variable by providing segments equivalent to the segments at that level.

33. The method as claimed in claim 32, wherein the variable is a filter, top, side, and weight.

34. The method as claimed in claim 32, wherein the segments are additional segments.

35. The method as claimed in claim 32, wherein the segments are collapsed.

36. A method of arranging variables in a grid configuration, the method comprising the steps of:
selecting one of the variables;
providing a grid structure; and
slotting the variable into the grid at a desired location.

37. An apparatus adapted to representing the structure of hierarchical data, said apparatus comprising:
processor means adapted to operate in accordance with a predetermined instruction set; and
said apparatus, in conjunction with said instruction set, being adapted to:
provide a first folder representing a variable;
provide at least one second folder, within the first folder, each second folder representing a level; and
provide within each second folder, one or more codes for that level.

38. A computer program product comprising:
a computer usable medium having computer readable program code and computer readable system code embodied on said medium for cooperating a data processing system, said computer program product including:
computer readable code within the computer usable medium being adapted to:
provide a first folder representing a variable;
provide at least one second folder, within the first folder, each second folder representing a level; and
provide within each second folder, one or more codes for that level.
